(19) United States
(12) Patent Application Publication
(10) Pub. No.: US 2015/0110625 A1
(43) Pub. Date: Apr. 23, 2015

(54) Ceiling fan and an accessory module for a ceiling fan

(71) Applicant: Indio da Costa Licensing Ltda., Rio de Janeiro (BR)

(72) Inventors: Luiz Augusto DE SIQUEIRA INDIO DA COSTA, Rio de Janeiro (BR); Felippe Morais BICUDO, Sao Paulo (BR)

(73) Assignee: INDIO DA COSTA LICENSING LTDA., Rio de Janeiro (BR)

(21) Appl. No.: 14/518,648

(22) Filed: Oct. 20, 2014

(30) Foreign Application Priority Data
Oct. 21, 2013 (BR) BR102013027038-5

(51) Int. Cl. F04D 25/08; F21V 33/00; B05B 3/02; F04D 29/38; A61L 9/12; F24H 3/04; F24F 3/16

(52) U.S. Cl. CPC F04D 25/088; F24H 3/04; F21V 33/0096; F24F 3/16; F04D 29/388; A61L 9/122; B05B 3/022
USPC 416/5; 416/62

(57) ABSTRACT

The present invention relates to a ceiling fan (1) with a modular structure, which comprises a central hub (2), from the periphery of which blades (3) extend. Said central hub (2) has top (12) and bottom (13) surfaces arranged on planes parallel to the ceiling. Besides, the ceiling fan (1) further has a driving motor, means (14) for fixing the central hub (2) to the ceiling, control means and electric and/hydraulic connection means connectable to sources of electric and/or hydraulic feed provided on the ceiling. The top (12) and (13) surfaces of the central hub (2) are provided with means (11) for fixing accessory modules. These accessory modules may consist of sources of illumination, sound propagation sound, air heaters, liquid spraying means, environment deodorizing means, air purifiers, among others.

The present patent application relates to a modular ceiling fan and its respective modules, which may have different purposes, such as illumination, air heating, air cleaning, liquid spraying, environment deodorizing, among others.

### DESCRIPTION OF THE PRIOR ART

Ceiling fans are exhaustively described in the prior art. However, with the constant advent of technology, the creation of more and more complete items having some differential becomes possible. Due to the wide variety of products offered on the market, it is necessary to present distinctive characteristics on the objects to be offered to the user.

Patent U.S. Pat. No. 5,899,663 shows a modular assembly used on ceiling fans, which can be composed by different styles and appearances. The motor, the shafts and the electric components have standardized configurations and sizes, as well as the opening for fitting the blades. The motor hub is formed by a number of fitting horizontal sections, which may vary according to the option chosen by the user. As a result, a motor hub is then formed which has upper and lower section with exchangeable styles.

Although this is a modular fan, the technology described in said document refers to interchangeable modules capable of changing only the esthetic characteristics of the fan, without making any comment on the functional characteristics thereof.

Patent U.S. Pat. No. 5,022,819 relates to a fragrance dispensing device that can be coupled to a ceiling fan. Said device has U-shaped clamps at its four ends, which is described as being the main differentiation of this object for the prior art. Such clams enable coupling this device directly to ceiling-fan blades.

The device described in said application has the specific purpose of deodorizing environments. Since the fan is an independent device, it does not necessarily have any other functional characteristic that is not present in the prior art. Besides, that fact that the device can be coupled to a common fan implies the need to acquire it independently of the fan itself.

On the other hand, U.S. Pat. No. 7,201,489 presents a device composed of a set of light emitting diodes (LEDs) which are mounted on a disc and coupled to a ceiling fan. The illumination is actuated through a hanging chain, which should be pulled to turn the light on or off. Said document provides better illumination of the environment by using a reflective protective cover, which has a focus effect refracting the light emitted by the LEDs.

In the claims, it is not clear whether the LED discs are positioned at the upper part or at the lower part of the fan. However, even if the LEDs can be coupled to both parts of the fan, the latter does not exhibit a modular structure that enables one to couple other devices.

Brazilian application for a utility model BRMU8402201, shelved in 2008, describes an improvement introduced on ceiling fans. Such an improvement consists in using the so-called “superleds” for illuminating environments, in order to increase the illuminating capability and decreasing the generation of heat. This improvement is achieved by means of a dissipating convex plate that enables symmetric fixation of the “superleds” and on which a transparent or translucent protection is arranged.

Although said document does not describe the object clearly, one understands that the improvement consists in using the so-called “superleds” only at the lower part of the ceiling fan, without creating indirect illumination by using LEDs at the upper part of the fan. Besides, the arrangement described in said document refers only to the illuminating apparatus per se, without any mention of ceiling fans with modules having other functionalities.

There is further the expired U.S. Pat. No. 4,782,213, filed in 1987, which describes a ceiling fan having electric air heaters coupled fixedly to their blades. The blades have free spaces inside them, where the resistances responsible for heating the air are arranged. The upper part and the lower part of each blade have a sort of “venetian blind” capable of diverting the ambient air and leading it toward the resistances contained inside the blades, and then lead it back into the environment, already duly heated.

The fan presented in said patent document has, as a differential, only the feature of heating air; it does not have interchangeable modules nor does it enable the use of other different functional characteristics.

As one can see, on the market and in the above contents there is no fan composed by a modular structure and that can enable one to couple various devices, each with a different functionality.

In this regard, the present invention presents a ceiling fan that enables coupling various types of devices according to the need of the user.

### OBJECTIVES OF THE INVENTION

The present invention has the main objective of offering convenience and a variety of functions to its users. Upon making use of the ceiling fan described in the present document, the user can benefit from a number of functionalities through a single object.

This objective is achieved by fitting permutable accessory modules, which can be coupled to the ceiling fan according to the need of the user.

One can further cite the objective of diminishing the volume of the goods stored at the manufacturing industries and at the resellers, since the latter need only to store the modules with different functions, of relatively small size as compared with the size of ceiling fans with different functions.

### BRIEF DESCRIPTION OF THE INVENTION

The present invention relates to a ceiling fan formed by a modular structure, which has the objective of providing a client with a variety of options of functionalities for said fans.

The ceiling fan described herein has means for fitting couplable modules onto the upper and lower surfaces of its central hub. These fitting means enable the user to employ modules with different functionalities, so that the ceiling fan will not have only the function of circulating the environment air.

According to the module chosen by the user, the fan may have additional functions, as for example: illumination, air heating, environment deodorizing, sound emitting, image capturing, image emitting, air cleaning, sensors, liquid spraying, among others.

### BRIEF DESCRIPTION OF THE FIGURES

The present invention will now be described in greater detail with reference to different embodiments represented in the figures. The figures show:

FIG. 1A—a top view of the main body of the ceiling fan in its variant with two blades and without accessory modules;

FIG. 1B—a bottom view of the main body of the ceiling fan in its variant with two blades and without accessory modules;

FIG. 2—a top view of the main body of the ceiling fan in its variant with two blades and with a LED chandelier coupled as a top module;

FIG. 3—a perspective view of the ceiling fan in its variant with two blades with a protective cover as a top module;

FIG. 4—a perspective view of the ceiling fan in its variant with three blades and with a protective cover as a top module;

FIG. 5—a perspective view of the ceiling fan in its variant with two blades and with a protective cover as a lower module;

FIG. 6—a perspective view of the ceiling fan in its variant with thee blades and with a protective cover as a lower module;

FIG. 7—a perspective view of the ceiling fan in its variant with two blades and a LED chandelier as a lower module;

FIG. 8—a perspective view of the ceiling fan in its variant with two blades and with a coupled LED chandelier as a lower module;

FIG. 9—a perspective view of the ceiling fan in its variant with three blades and with a coupled LED chandelier as a top module;

FIG. 10—a perspective view of the ceiling fan in its variant with three blades and a coupled LED chandelier as a top module;

FIG. 11—a front view of the ceiling fan in its variant with three blades and coupled LED chandeliers as top module and as lower module.

### SUMMARY OF THE INVENTION

The present invention relates to a ceiling fan with fitting means for fitting accessory modules, as well as its respective modules. The ceiling fan may have two, three, four or more fitting means for the accessory modules on each of its top and bottom surfaces. In this way, the ceiling fan can receive two different accessory modules on the same surface, as for example, a sound propagation means and a LED chandelier on its lower surface.

The ceiling fan described herein comprises a central hub, from the periphery of which blades extend. Said central hub has top and bottom surfaces on planes parallel to the ceiling, besides having a drive motor, means for fixing said hub to the ceiling, control means and electric and/or hydraulic connection means, connectable to electric and/or hydraulic sources provided on the ceiling.

The characteristic that differentiates the fan described herein from the prior art is that fact that its top and bottom surfaces are provided with fitting means for accessory modules, where different modules can be fitted. Such modules may consist of light sources, sets of light-emitting diodes, liquid-spraying nozzles, sound-propagation means, cameras, air-heating devices, protective covers, information-display means, air cleaners, sensors, among others.

The fan may have various means for increasing its resistance and durability, as for instance, the fact that the blades may be made from polycarbonate. Optionally, the ceiling fan might also be made from metal, carbon fiber or any other functionally compatible material. The existence of a chamfer close to the motor and of the curvature along the blades, also increase the resistance and durability of the object.

The blades may further rely upon aerodynamic components capable of increasing the air flow and decreasing the noise emitted by the fan, such as the so-called “winglets”, small folds at the blade tips that are intended for such purpose.

### DETAILED DESCRIPTION OF THE FIGURES

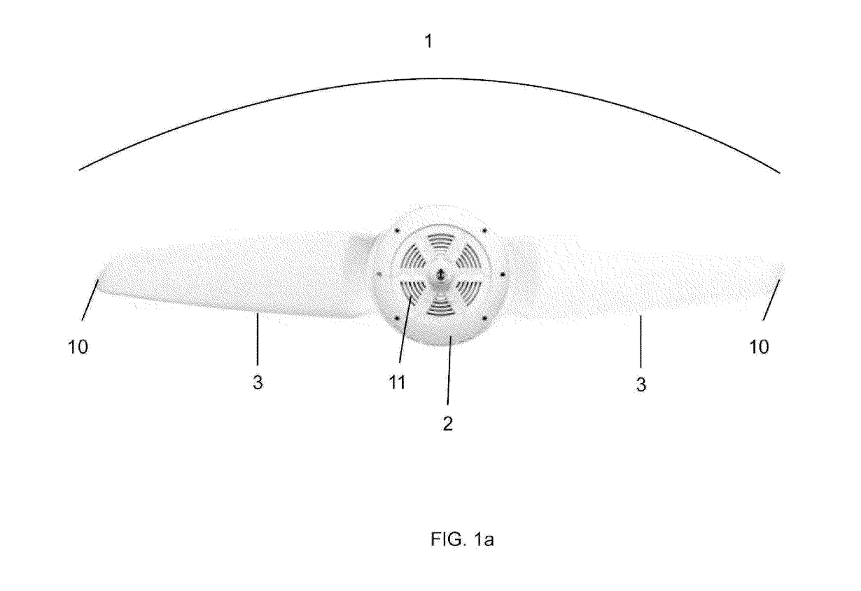

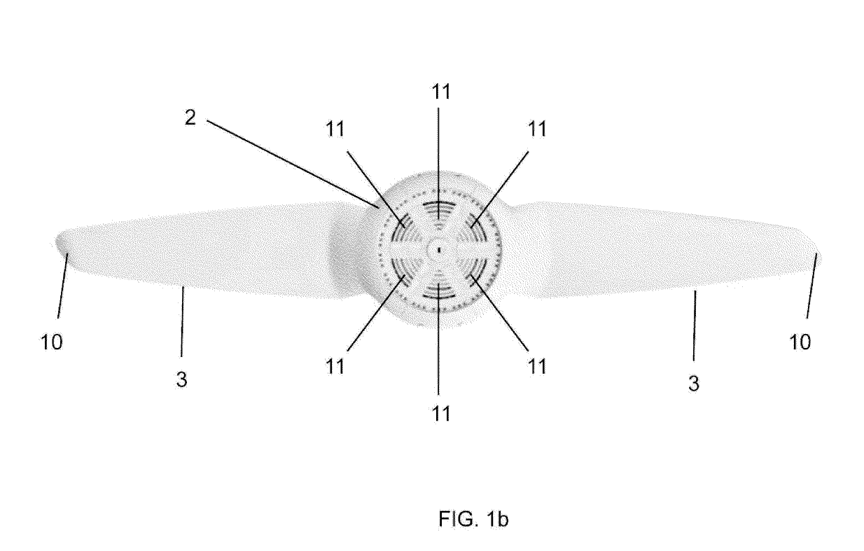

FIGS. 1A and 1B show, respectively, a top view and a bottom view of the ceiling fan 1 in its variant with two blades 3 and without any accessory module, which makes it possible to view the fitting means 11 present on its top 12 and bottom 13 surfaces. The fan 1 can be employed by the user only to ventilate the environment, and it is not compulsory to couple the additional modules.

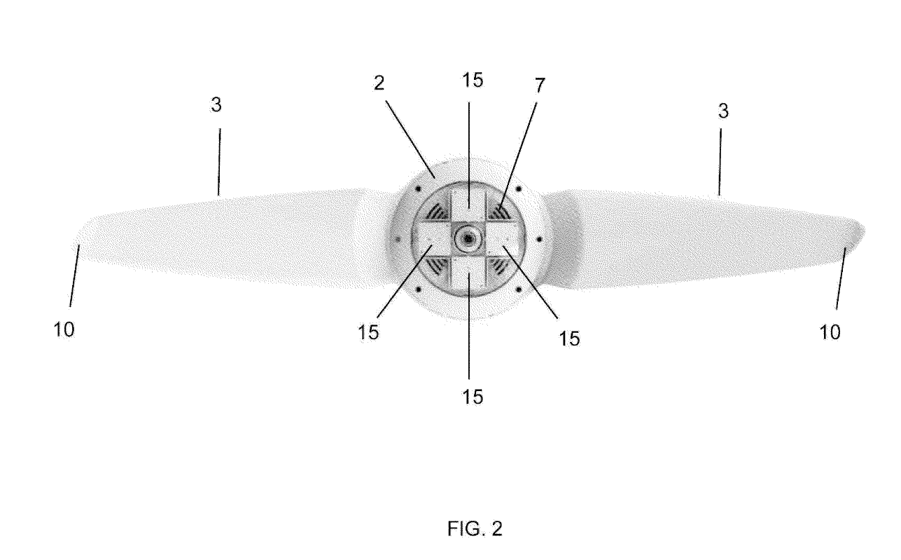

FIG. 2 shows a top view of the ceiling fan 1 in its variant with two blades 3 with a set of light emitting diodes, called also LED chandeliers 7, coupled to the fitting means 11 on the top surface.

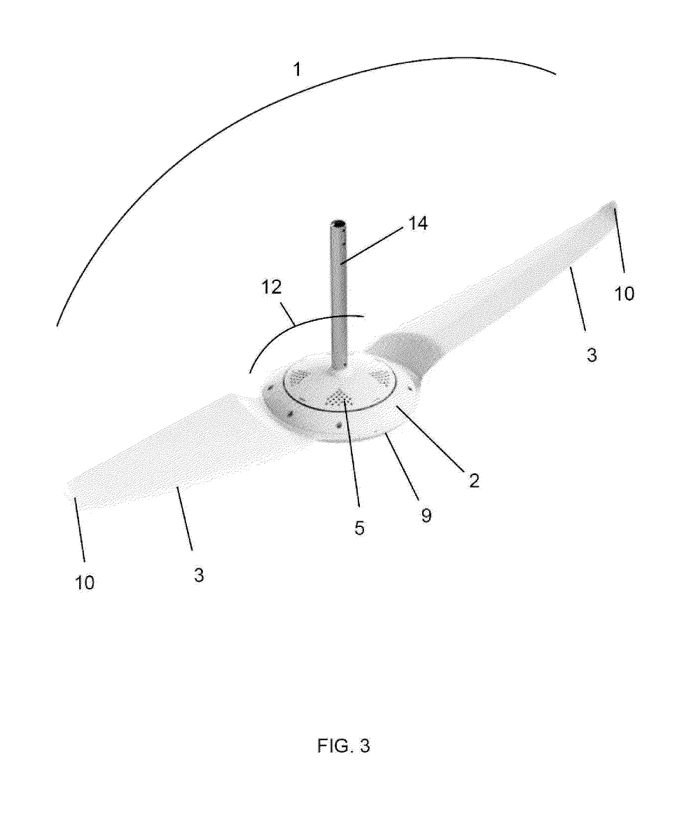

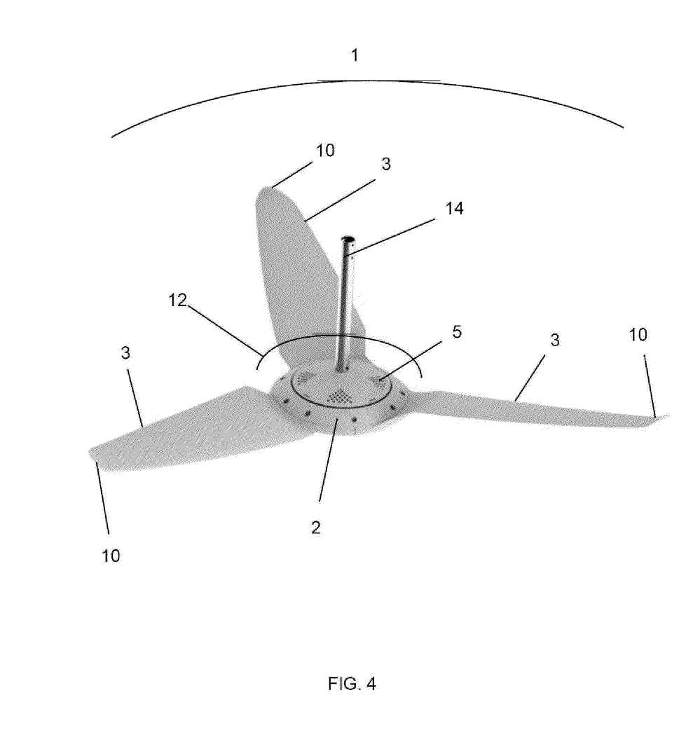

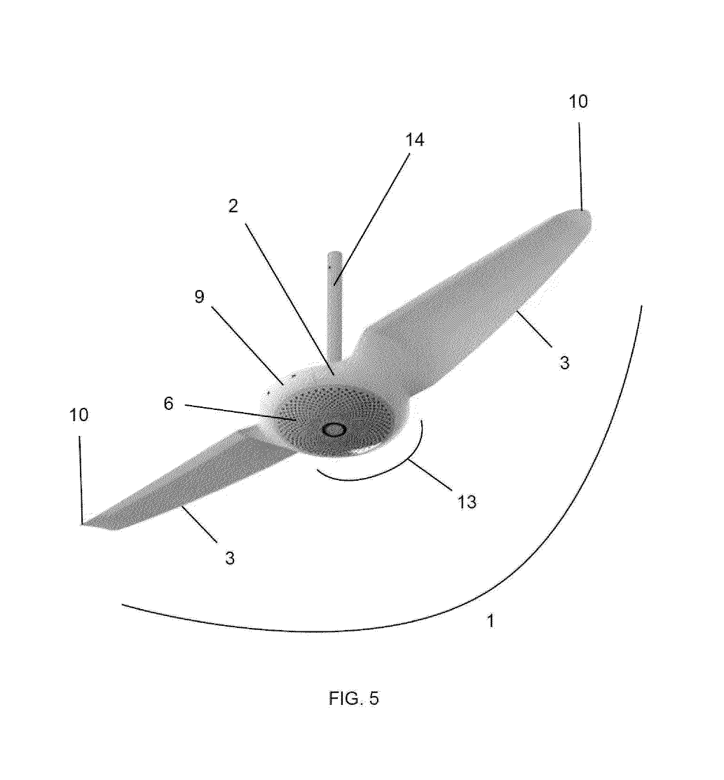

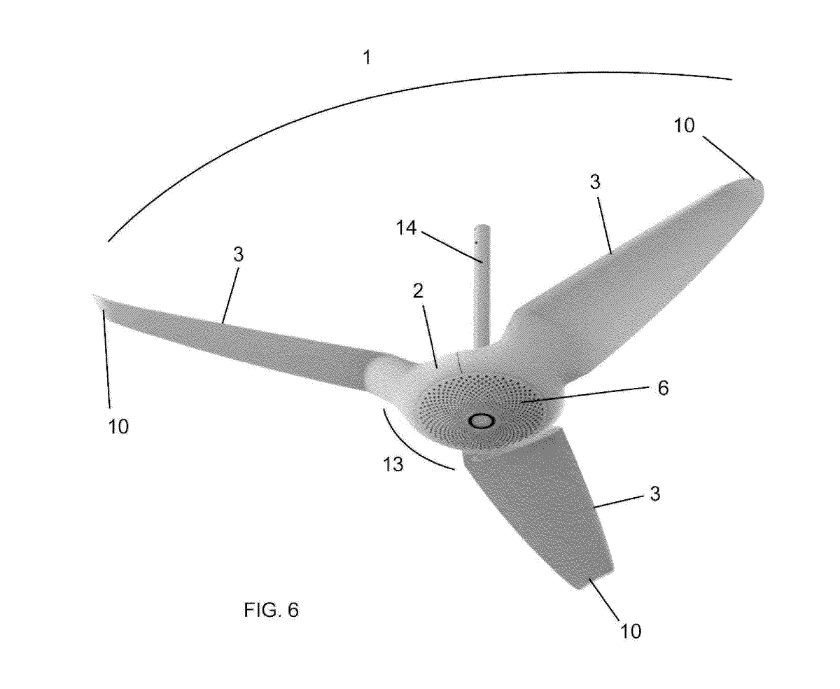

FIGS. 3, 4, 5, and 6 show different embodiments of the ceiling fan 1. For esthetic purposes, the user may couple protective covers 5, 6 to the top 12 and bottom 13 surfaces of the ceiling fan 1. In this way, the user can use the ceiling fan 1 only to circulate environment air and even so maintain a pleasant visual aspect. Besides, the protective covers 5, 6 have the objective of preventing the fitting means 11 and the accessory modules from coming into contact with dirt, insects and the like.

As can be seen in the figures, the fan 1 may have variants with two or three blades 3, according to the option chosen by the user. In the embodiments in which the fan 1 has three blades 3, one can observe that the blades 3 are releasably coupled by means of screws, each of them occupying 120 degrees of the circular perimeter of the central hub 2. In the embodiments in which the fan 1 has only two blades 3, the blades 3 must be coupled to opposite sides of said periphery of the ceiling fan 1. Each blade 3 will occupy 120 degrees of the circular perimeter of the central hub 2. The two remaining 60-degree spaces may be covered with protective elements 9.

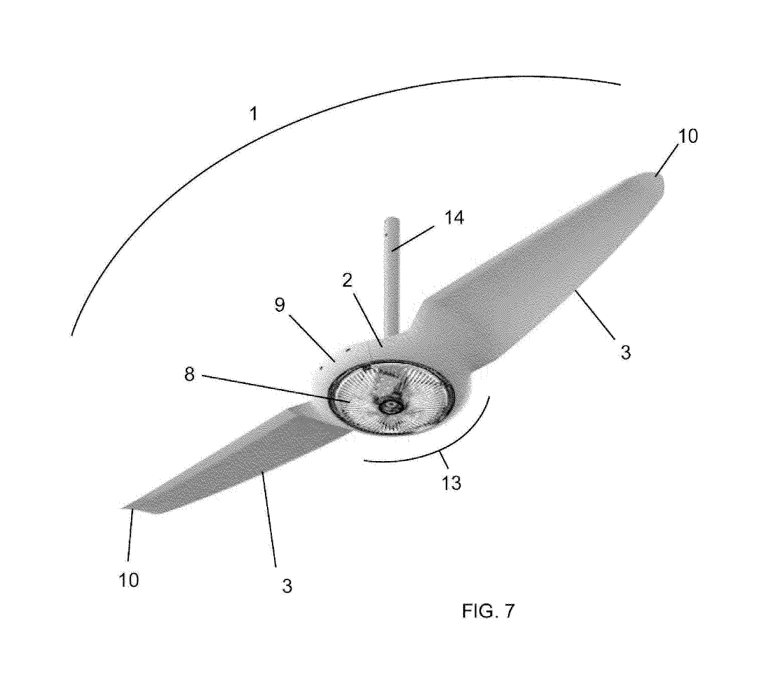

In other embodiments of the ceiling fan 1, sources of light may be coupled to the fitting means 11. These sources of light may be incandescent lamps, fluorescent lamps or LED lamps. In FIGS. 7, 8, 9, 10, and 11, one can observe LED chandeliers 7, 8 connected to the fitting means 11 by means of connection means and electric feed means between the fan hub 2 and the ceiling. The LED chandeliers 7, 8 may be subdivided into four equal plates 15, arranged inclined, so as to provide better distribution of light to the user.

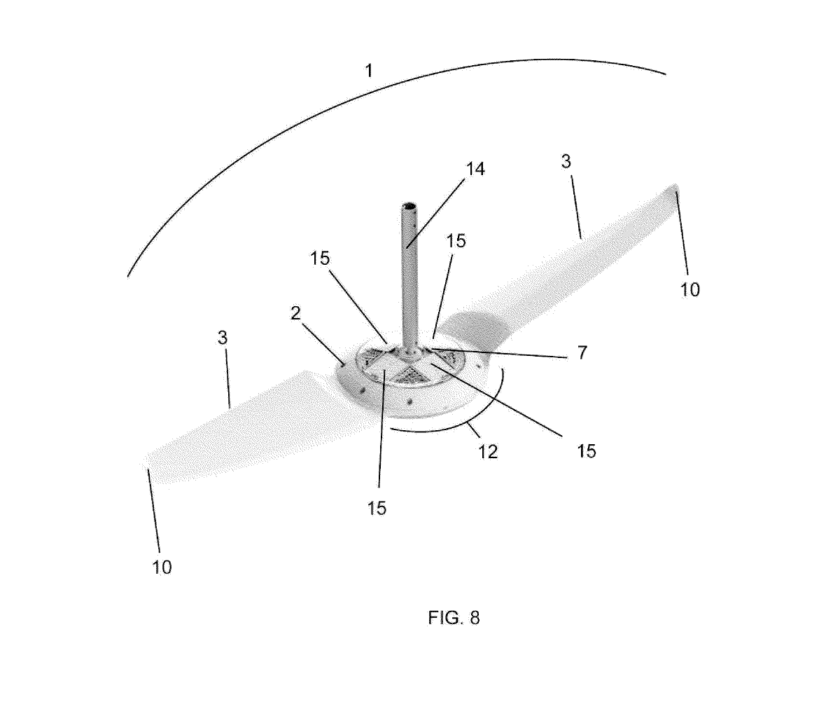

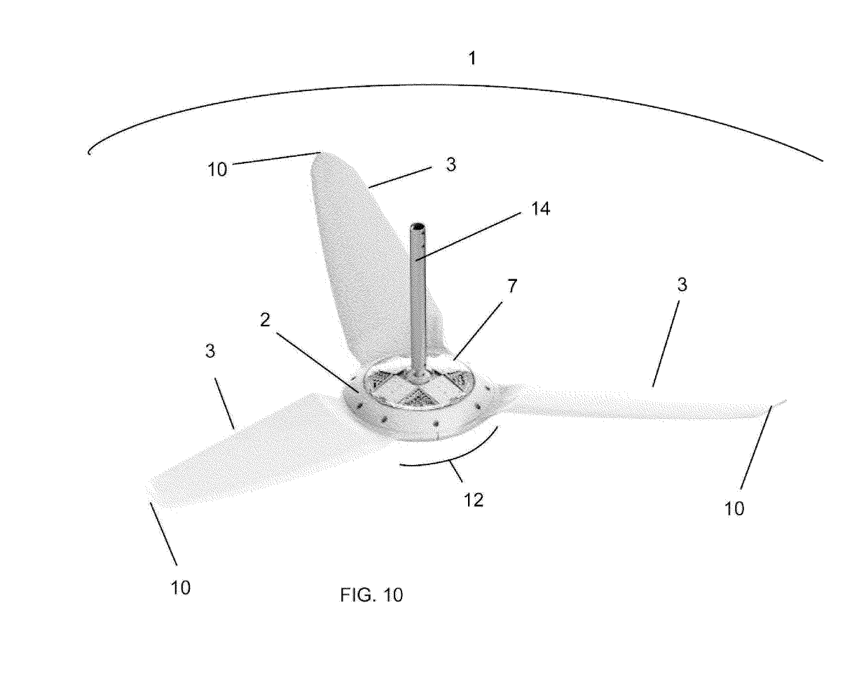

There is the possibility of coupling LED chandeliers 7 to the fitting means 11 of the top surface 12, so that the chandeliers 7 will face the ceiling, as can be observed in FIGS. 8 and 10. In this way, the ceiling will be used as a fixation surface for the light coming from the LED chandelier 7, providing pleasant indirect illumination for the whole environment.

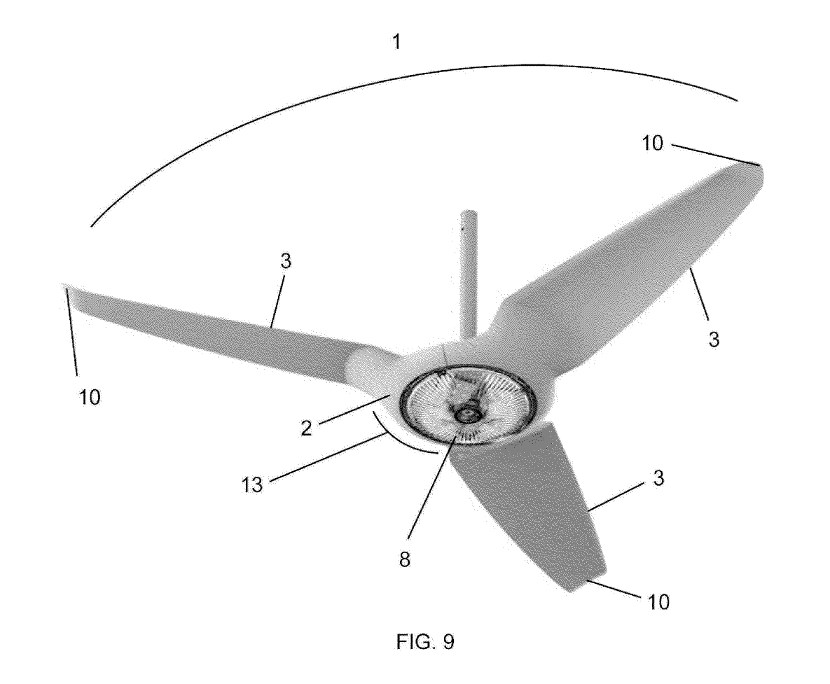

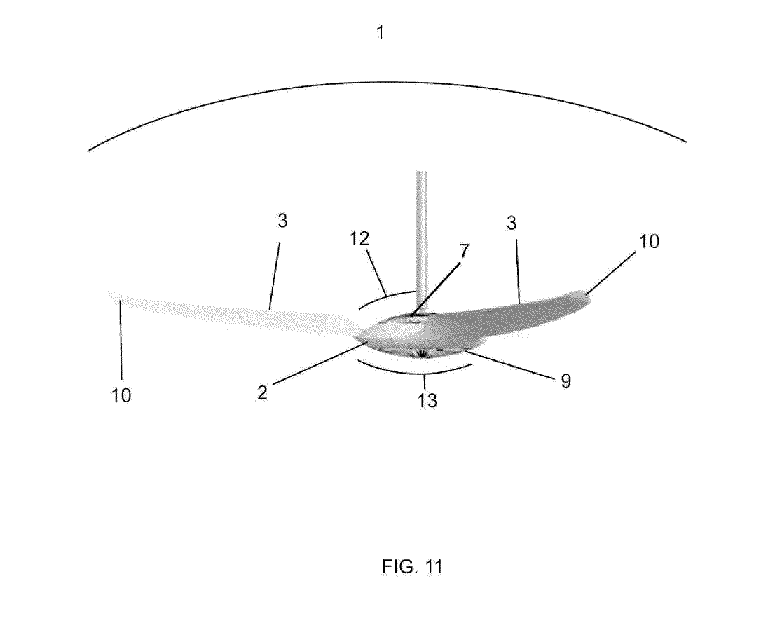

There is further the possibility of coupling the LED chandelier 8 to the fitting means 11 of the bottom surface 13, so as to provide direct illumination, as shown in FIGS. 7 and 9. Optionally, one may further use LED chandeliers 7, 8 coupled to both the top surface 12 and the bottom surface 13 of the ceiling fan 1, thus providing direct and indirect illumination, as shown in FIG. 11.

In another embodiment of the ceiling fan 1, one may couple sound propagation means electrically connectable by fitting to one of the surfaces of the central hub 2 of the ceiling fan 1. Upon actuation of this module, the sound coming from the sound boxes propagates throughout the environment, in a practical and convenient manner.

In a further embodiment, one may coupled to any of the modules an accessory that will provide odor dispersing means. Upon actuation this accessory will expel a pleasant aroma into the environment, according to the preference of the user. This accessory may include refills that will be changed by the user in a simple and practical manner, since they will be totally interchangeable.

There are various other embodiments for the ceiling fan 1. For example, one can cite the heating module, which enables heating the air circulated in the environment. Another embodiment enables coupling a module that will purify the air of the environment in which the fan is installed.

In an optional embodiment of the present invention, one may couple sensors to any of the fitting means 11. These sensors may consist of thermometers, smoke detectors, human-presence detectors, carbon-monoxide detectors, and other types of sensors.

One can also cited the fan 1 with a module that has liquid spraying nozzles. In order to couple such a module to the fan 1, connection means and hydraulic feed means are necessary between the fan 1 and the ceiling. In this way, when the liquid spraying module is actuated, smooth jets of liquids are emitted into the environment, in order to provide pleasant freshness to the user. Besides, the liquid spraying module can be used as a sort of automatic shower for fire extinction, called also “sprinkler”.

In another embodiment of the present invention, one may couple sensors to any of the fitting means 11. These sensors may consists of thermometers, smoke detectors, human presence detectors, carbon-monoxide detectors or detectors of other toxic gases and other types of sensors.

Additionally, one may couple a module that comprises at least one camera electrically connectable by fitting one of the surfaces of the central hub 2, in order to record images of the environment.

There is still the option of coupling information displaying means on the bottom surface 13 of the ceiling fan. Such information displaying means may be monitors, tablets, pamphlets, billboards or any other types of devices that can be used for such purposes.

Only a few examples of embodiments having been described above, one should understand that the scope of the present invention embraces other possible variations.

1. A ceiling fan (1) of the type that comprises a central hub (2), from the periphery of which blades (3) extend, said hub (2) having top (12) and bottom (13) surfaces arranged on planes parallel to the ceiling, a driving motor, means (14) for fixing the central hub (2) to the ceiling, a control mechanism and electric and/or hydraulic connection means, connectable to electric feed sources provided on the ceiling;
characterized in that said top (12) and bottom (13) surfaces of the hub (2) are provided with at least one fitting means (11) for fitting accessory modules.

2. The ceiling fan (1) according to claim 1, characterized in that the accessory modules include sets of light emitting diodes (7, 8) electrically connectable through said electric connection means of the central hub (2).

3. The ceiling fan (1) according to claim 1, characterized in that the accessory means include liquid spraying nozzles connectable to hydraulic connection means of the central hub (2) provided on the ceiling.

4. The ceiling fan (1) according to claim 1, characterized in that said central hub is provided with two accessory-module fitting means (11) on its bottom surface (13), to which two accessory modules are coupled, the first one being a sound propagation means and the second one being a LED chandelier (8).

5. The ceiling fan (1) according to claim 1, characterized in that said blades (3) are produced from polycarbonate.

6. An accessory module for a ceiling fan (1) like that defined in claim 1, characterized by comprising at least one source of light electrically connectable by fitting to said central hub (2).

7. The accessory module for a ceiling fan (1) according to claim 6, characterized in that said at least one source of light is a set (7, 8) of light emitting diodes.

8. An accessory module for a ceiling fan (1) like that defined in claim 1, characterized in by comprising at least one liquid spraying nozzle hydraulically connectable by fitting to hydraulic connection means of the central hub (2) provided on the ceiling.

9. An accessory module for a ceiling fan (1) like that defined in claim 1, characterized by comprising odor dispersing means connectable by fitting to at least one of the surfaces (12, 13) of said central hub (2).

10. An accessory module for a ceiling fan (1) like that defined in claim 1, characterized by comprising sound propagation means electrically connectable by fitting to at least one of the surfaces (12, 13) of said central hub (2).

11. An accessory module for a ceiling fan (1) like that defined in claim 1, characterized by comprising at least one camera connectable by fitting to at least one of the surfaces (12, 13) of said central hub (2).

12. An accessory module for a ceiling fan (1) like that defined in claim 1, characterized by comprising an air heating device connectable by fitting to at least one of the surfaces (12, 13) of said central hub (2).

13. An accessory module for a ceiling fan (1) like that defined in claim 1, characterized by comprising a protective cover (5, 6) connectable by fitting to at least one of the surfaces (12, 13) of said central hub (2).

14. An accessory module for a ceiling fan (1) like that defined in claim 1, characterized by comprising information display means connectable by fitting to at least one of the surfaces (12, 13) of said hub (2).

15. The accessory module for a ceiling fan (1) according to claim 14, characterized in that the information display means consists of a monitor.

16. An accessory module for a ceiling fan (1) like that defined in claim 1, characterized by comprising air purifying means connectable by fitting to at least one of the surfaces (12, 13) of said central hub (2).

17. An accessory module for a ceiling fan (1) like that defined in claim 1, characterized by comprising sensors electrically connectable by fitting to at least one of the surfaces (12, 13) of said central hub (2).
